(19) United States
(12) Patent Application Publication
(10) Pub. No.: US 2026/0141402 A1
(43) Pub. Date: May 21, 2026

(54) RESPONSE SUPPORT DEVICE, RESPONSE SUPPORT METHOD, AND PROGRAM

(71) Applicant: NTT TechnoCross Corporation, Tokyo (JP)

(72) Inventors: Kenichi MATSUSHIGE, Tokyo (JP); Yusuke KOBAYASHI, Tokyo (JP); Tatsuo KATOH, Tokyo (JP)

(73) Assignee: NTT TechnoCross Corporation, Tokyo (JP)

(21) Appl. No.: 19/113,813

(22) PCT Filed: Mar. 29, 2023
(86) PCT No.: PCT/JP2023/012932

§ 371 Date: Mar. 20, 2025

(51) Int. Cl. G06Q 30/015; H04M 3/51

(52) U.S. Cl. CPC G06Q 30/015; H04M 3/5183

(57) ABSTRACT

A response support device according to one aspect of the present disclosure includes a screen provider configured to provide a first screen including state information indicating a state of a first user providing customer service by predetermined communication means and warning information indicating occurrence of a specific event during communication by the communication means, to a second user terminal used by a second user supporting the customer service provided by the first user.

### TECHNICAL FIELD

The present disclosure relates to a response support device, response support method, and a program.

### BACKGROUND ART

Conventionally, there has been known a technique (e.g., see Patent Document 1) in which a supervisor can monitor the contents of a call between an operator and a customer in a call center (also called a contact center). Here, the supervisor is a person who supports the telephone response work of the operator when an issue such as trouble occurs or is likely to occur between the operator and the customer, or in response to a request or the like from the operator.

The support of the telephone response work is performed in various ways, but it is generally performed orally, by handwritten notes, or the like.

### RELATED ART DOCUMENTS

### Patent Documents

Patent Document 1: Japanese Laid-Open Patent Application No. 2016-119634

### SUMMARY OF THE INVENTION

### Problems to be Solved by the Invention

However, in the existing technique, it is assumed that the operator and the supervisor physically report to the contact center and that the operator and the supervisor work together in the contact center. In contrast to the assumption, in recent years, due to the diversification of working styles and the like, there are many cases in which one or both of the operator and the supervisor perform work remotely from home and other remote locations by teleworking. Therefore, in the existing technique, a situation may occur in which a supervisor cannot sufficiently support an operator's telephone response work.

The present disclosure has been made in view of the above, and provides a technique capable of supporting an operator's response work.

### Means for Solving the Problems

A response support device according to one aspect of the present disclosure includes a screen provider configured to provide a first screen including state information indicating a state of a first user providing customer service by predetermined communication means and warning information indicating occurrence of a specific event during communication by the communication means, to a second user terminal used by a second user supporting the customer service provided by the first user.

### Advantageous Effects of the Invention

A technique capable of supporting a response work is provided.

### BRIEF DESCRIPTION OF THE DRAWINGS

FIG. 1 is a figure illustrating an example of an overall configuration of a contact center system according to a present embodiment.

FIG. 2 is a figure illustrating an example of a functional configuration of a response support server, an operator terminal, and a supervisor terminal according to the present embodiment.

FIG. 3 is a figure illustrating an example of a supervisor screen.

FIG. 4 is a figure illustrating an example of the supervisor screen when checking contents of a call of an operator in which a keyword is detected.

FIG. 5 is a figure illustrating an example of the supervisor screen when checking the contents of a call of an operator whose on-call time duration exceeds a predetermined period of time.

FIG. 6 is a figure illustrating an example of the supervisor screen when checking the contents of a call of an operator whose holding time exceeds a predetermined period of time.

FIG. 7 is a figure illustrating an example of the supervisor screen when checking the contents of a call of an operator who has made a help request.

FIG. 8 is a figure illustrating an example of the supervisor screen when checking the contents of the call of the operator who has made a help request with a specified utterance text.

FIG. 9 is a figure illustrating an example of the supervisor screen including shared memos.

FIG. 10 is a figure illustrating an example of an operator screen.

FIG. 11 is a figure illustrating an example of the operator screen after a help request.

FIG. 12 is a figure illustrating an example of the operator screen when the help request is made with a specified utterance text.

FIG. 13 is a figure illustrating an example of the operator screen after the help request is confirmed.

FIG. 14 is a figure illustrating an example of the operator screen including the shared memos.

FIG. 15 is a figure illustrating a modified example of the supervisor screen.

### DETAILED DESCRIPTION OF THE INVENTION

One embodiment of the present disclosure will be described in the following. In the following embodiment, a contact center system 1 for a contact center (or a call center) in which a supervisor can support operator's telephone response work (customer service work by telephone) even when at least one of the operator or the supervisor is teleworking is described. Hereinafter, the work for supporting the telephone response work is also referred to as “telephone response support work”. However, the contact center is an example, and is not limited to this. In addition to the contact center, for example, the contact center system 1 can also be applied to support the response work of a person in charge of sales of products, services, etc., or a person in charge of tellers, etc., in an office, a store, or the like. Furthermore generally, the contact center system 1 can also be applied to support a response of one person (can be one or more people) to another person in a conversation of some kind.

Furthermore, in the following description, it is assumed that the operator performs work such as answering inquiries with customers by voice calls, but this is not limited to this, and the same can be applied to work performed by text chat (including those enabling sending and receiving of text, stamps, and attached files, etc.), video calls, etc. Furthermore generally, the same can be applied to the customer service work performed by any communication means by using at least one of voice, video, text (including stamps, attached files, etc.), or the like among a plurality of persons including customers.

### <Example of Overall Configuration of Contact Center System 1>

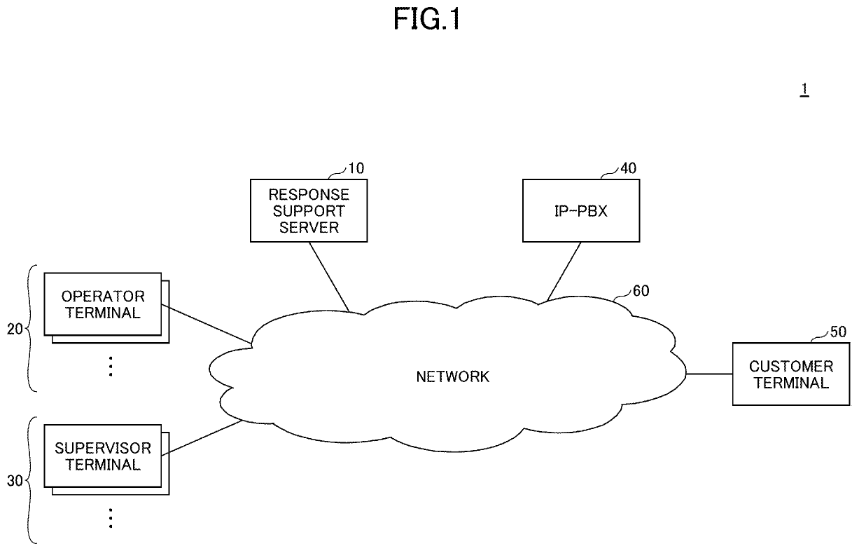

FIG. 1 is a figure illustrating an example of overall configuration of the contact center system 1 according to the present embodiment. As illustrated in FIG. 1, the contact center system 1 according to the present embodiment includes a response support server 10, one or more operator terminals 20, one or more supervisor terminals 30, IP-PBX 40, and a customer terminal 50. They are intercommunicably connected via a network 60 including various communication networks such as a local area network (LAN), a wide area network (WAN), the Internet, a voice over Internet protocol (VoIP) network, a public switched telephone network (PSTN), etc.

The response support server 10 is a server or a group of servers providing various functions for supporting the telephone response work of the operator and the telephone response support work of the supervisor. Although there are various functions provided by the response support server 10, at least the functions described in (1) to (3) in the following are provided as a prerequisite for the present embodiment.

(1) Voice recognition function: This function creates an utterance text in which a voice call between an operator and a customer is converted into text with time information for each speaker by a voice recognition technique by using a packet (voice packet) transferred from the IP-PBX 40.

(2) Utterance text providing function: This function provides the operator terminal 20 with a screen (hereinafter, also referred to as an operator screen) in which the UI component representing the utterance text created by the aforementioned voice recognition function can be checked in real time for each speaker. This function enables the operator to check the contents of the call made with the customer (that is, the utterance contents of the customer and the operator) in real time during the call. The UI component is an icon, a button, a figure, a character, etc. displayed on the screen. The UI component may be operable or not operable by a user. Hereinafter, a UI component representing an utterance text is also referred to as an “utterance component”.

(3) Monitoring function: This function provides the supervisor terminal 30 with a screen (hereinafter, also referred to as a supervisor screen) that allows to confirm in real time a call status (for example, “available”, “on call”, “on hold”, etc.) of one or more operators to be monitored by the supervisor and the call contents of the operator whose call status is “on call” or “on hold”. It should be noted that the supervisor generally monitors several operators.

At this time, the response support server 10 according to the present embodiment further displays on the supervisor screen an “operator status” indicating the presence or absence of psychological stress or the like of the operator and an “alert” (warning) indicating the occurrence of some issues in the call of the operator. Thus, since the supervisor can confirm the presence or absence of psychological stress or the like of the operator and the presence or absence of an alert in the call, it is possible to effectively support the telephone response work of the operator even when the supervisor or the operator is teleworking.

Furthermore, the response support server 10 according to the present embodiment further displays on the operator screen a UI component for requesting the support of the telephone response work of the operator to the supervisor who monitors the operator, and can confirm on the operator screen whether or not the supervisor has confirmed the support request (hereinafter, this support request is also referred to as a “help request”). Thus, the operator can request help from the supervisor from the operator screen, for example, without actually raising his or her hand, and can know whether or not the supervisor has confirmed the help request on the operator screen, such that the operator can effectively receive support from the supervisor even when the supervisor or the operator is teleworking.

Furthermore, when the operator requests help from the supervisor who monitors the operator, the response support server 10 according to the present embodiment enables the operator to request help by specifying a specific utterance text in addition to usual help requests. Thus, the operator can request support regarding the specific utterance text, and can effectively receive support from the supervisor.

In addition, the response support server 10 according to the present embodiment provides a memo (hereinafter, also referred to as a “shared memo”) that can be shared between the operator screen and the supervisor screen in real time as a tool for the supervisor to actually support the operator. Thus, the operator and the supervisor can communicate with each other on the shared memo in real time, and effective and efficient support can be achieved.

It should be noted that the response support server 10 may provide various functions other than (1) to (3) described above. For example, the response support server 10 may provide a function to provide the operator with knowledge such as an FAQ, a function to provide the operator with customer information (name, age, sex, address, purchase history of goods and services, etc.), and a function to provide the operator with a summary of past calls of the customer who is currently answering the phone. However, these are only examples, and the response support server 10 may provide various other functions.

The operator terminal 20 can be any terminal (for example, a personal computer (PC), a smartphone, a tablet terminal, a wearable device, etc.) used by an operator. Here, the operator terminal 20 may be installed in the contact center and used by an operator who goes to the contact center, or it may be installed in the operator's home, shared office, etc., and used during telework. Alternatively, the operator terminal 20 may be installed in the contact center and used during telework by remote connection from a terminal installed in the operator's home, shared office, etc.

It is assumed that the operator terminal 20 is equipped with application software called a softphone or the like and has a telephone function. However, the operator terminal 20 may not have the telephone function, and in this case, a telephone used by the operator exists separately from the operator terminal 20.

The supervisor terminal 30 can be any terminal (for example, a personal computer (PC), a smartphone, a tablet terminal, a wearable device, etc.) used by a supervisor. Here, the supervisor terminal 30 may be installed in the contact center and used by a supervisor who goes to the contact center, or may be installed in the supervisor's home, shared office, etc., and used during telework. Alternatively, the supervisor terminal 30 may be installed in the contact center and used during telework by remote connection from a terminal installed in the supervisor's home, shared office, etc.

The supervisor terminal 30 may be equipped with application software called a softphone or the like, and may have a telephone function.

The IP-PBX 40 is a server or server group that functions as a cloud-based telephone exchange (Internet protocol private branch exchange (IP-PBX)). The IP-PBX 40 relays voice packets between the operator terminal 20 and the customer terminal 50, captures the voice packets, and transmits (transfers) them to the response support server 10.

The customer terminal 50 can be any terminal such as a smartphone, a cellular phone, or a landline telephone used by a customer.

Note that the overall configuration of the contact center system 1 as illustrated in FIG. 1 is an example and is not limited thereto, and other configurations may be used as long as the various functions or processes described in the present embodiment can be implemented.

### <Example of Functional Configuration of Response Support Server 10, Operator Terminal 20, and Supervisor Terminal 30>

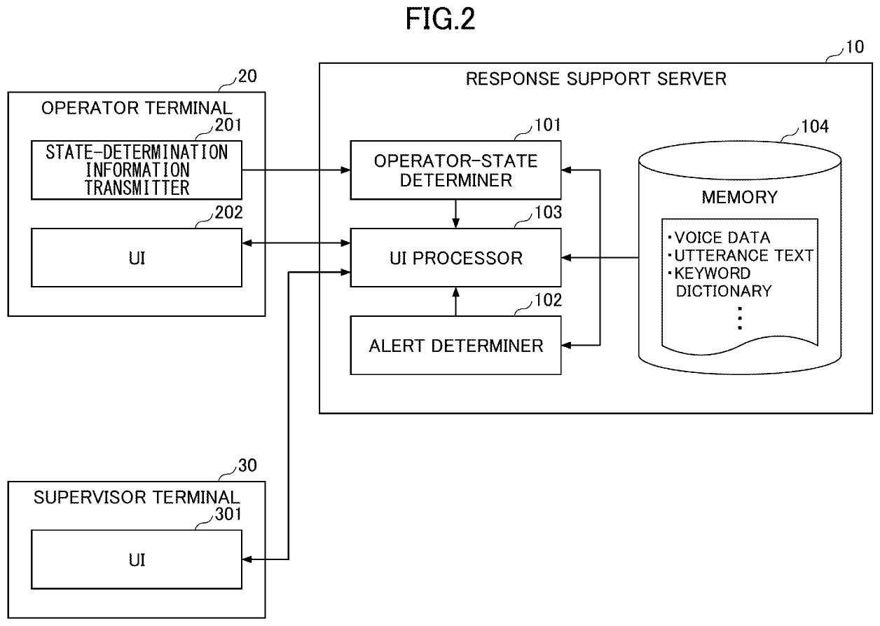

FIG. 2 is a figure illustrating an example of a functional configuration of the response support server 10, the operator terminal 20, and the supervisor terminal 30 according to the present embodiment.

### <<Response Support Server 10>>

As illustrated in FIG. 2, the response support server 10 according to the present embodiment includes an operator-state determiner 101, an alert determiner 102, a UI processor 103, and a memory 104. The operator-state determiner 101, the alert determiner 102, and the UI processor 103 are achieved, for example, by processing that one or more programs installed in the response support server 10 are executed by a processor such as a central processing unit (CPU). The memory 104 is achieved, for example, by an auxiliary memory device such as a hard disk drive (HDD), a solid state drive (SSD), or a flash memory. It should be noted that all or part of the storage area of the memory 104 may be achieved by a memory device such as a database server connected to the response support server 10 via the network 60.

When the operator-state determiner 101 receives state determination information from the operator terminal 20, an operator status of the operator using the operator terminal 20 is determined by using the state determination information. Here, the state determination information is information for determining the operator status, such as a photographed image of the operator's face, biological information of the operator (information such as a heart rate), and voice data of the operator. The operator-state determiner 101 may determine the presence or absence of psychological stress or the level of psychological stress, etc. from the state determination information for each operator by using a known psychological stress determination technique, an emotion analysis technique, etc., and use a result of the determination as the operator status of the operator.

The alert determiner 102 determines whether or not an event that should be determined to be an alert has occurred in a call between the customer and the operator at predetermined time intervals (for example, every second to every several seconds). Hereinafter, the following three types of alerts are assumed.

### Keyword Detection

The length of the on-call time duration exceeds a predetermined period of time.
Holding time exceeds a predetermined period of time.
   “Keyword detection” is an alert indicating that a predetermined keyword (in particular, a negative keyword that may lead to a customer grievance (complaint) or the like) has been detected in the utterance text of the call. “The length of the on-call time duration exceeds a predetermined period of time” is an alert indicating that the length of the on-call time duration of the call has exceeded a predetermined threshold value. “Holding time exceeds a predetermined period of time” is an alert indicating that the length of the holding time of the call has exceeded a predetermined threshold value. In the following, as one example, the threshold value for the on-call time duration is “3 minutes” and the threshold value for the holding time is “1 minute”. However, these threshold values are only examples, and any time length can be set as the threshold value.

The UI processor 103 provides the operator screen to the operator terminal 20 and the supervisor screen to the supervisor terminal 30. When the UI processor 103 receives operation information about the operator screen and operation information about the supervisor screen, the UI processor 103 executes processing corresponding to the operation information. The operation information is information indicating a type and an operation position of the operation performed on the screen by a user. Here, “executing processing corresponding to the operation information” means, when the operation information indicates that the UI component has been selected, for example, that a process that corresponds to the selection operation of the UI component is executed. For example, when a new UI component is displayed on a certain screen or a screen transition is made by the selection operation of the UI component, displaying processing and screen transition processing are executed.

The UI processor 103 may not provide the operator screen or the supervisor screen, but may provide only information necessary for generating and displaying those screens at the operator terminal 20 or the supervisor terminal 30. At this time, the operator terminal 20 or the supervisor terminal 30 may also execute processing for displaying a new UI component or making a screen transition in response to an operation on the operator screen or the supervisor screen. This makes it possible for the operator terminal 20 or the supervisor terminal 30 to execute processing or the like for displaying a screen (including screen transition and display of UI components, etc.) corresponding to the operation of the user (operator, supervisor, etc.) independently of the response support server 10.

The memory 104 stores various types of information or data. The various types of information or data stored in the memory 104 include, for example, voice data (that is, the voice data contained in the voice packets captured by the IP-PBX 40) recorded from a call between a customer and an operator, an utterance text obtained by converting the voice data into text with time information for each speaker by the voice recognition function, a keyword dictionary used for keyword detection by the alert determiner 102, and the like. Here, the keyword dictionary is a set of keywords to be detected. The keywords included in the keyword dictionary are often negative keywords that may lead to a customer grievance (complaint) or the like, for example, keywords such as “hurry”, “send the boss”, “trouble”, etc.

The various types of information or data stored in the memory 104 are examples, and various types of information or data other than the above information or data may be stored.

### <<Operator Terminal 20>>

As illustrated in FIG. 2, the operator terminal 20 according to the present embodiment includes a state-determination information transmitter 201 and a UI 202. The state-determination information transmitter 201 is achieved, for example, by making a processor such as a CPU execute one or more programs installed in the operator terminal 20. The UI 202 is achieved, for example, by making a processor such as a CPU execute one or more programs including a Web browser installed in the operator terminal 20.

The state-determination information transmitter 201 transmits the state determination information obtained or collected by the operator terminal 20 to the response support server 10 at predetermined time intervals (for example, every second to every several seconds, every photographing cycle of the camera, every sensing cycle of the sensor, etc.). The state determination information that can be obtained or collected by the operator terminal 20 includes, for example, a photographed image of the operator's face, biological information of the operator (information such as a heart rate), and voice data of the operator. However, since the voice data included in the voice packets captured by the IP-PBX 40 is stored in the memory 104, the voice data of the operator need not be obtained or collected by the operator terminal 20.

Instead of transmitting the state determination information to the response support server 10, the state-determination information transmitter 201 may determine the operator status from the state determination information and transmit only a determination result to the response support server 10. Alternatively, when a server (hereinafter, referred to as a state determination server) that determines the operator status from the state determination information exists separately from the response support server 10, the state-determination information transmitter 201 may transmit the state determination information to the state determination server, and the determination result of the operator status determined by the state determination server may be transmitted from the state determination server to the response support server 10.

The UI 202 displays the operator screen provided from the response support server 10 on a display device such as a display, and receives various operations of the operator on the operator screen and transmits the operation information to the response support server 10.

### <<Supervisor Terminal 30>>

As illustrated in FIG. 2, the supervisor terminal 30 according to the present embodiment includes a UI 301. The UI 301 is achieved by, for example, processing performed by a processor, such as a CPU, executing one or more programs including a Web browser installed in the supervisor terminal 30.

The UI 301 displays the supervisor screen provided from the response support server 10 on a display device such as a display, and receives various operations of the supervisor on the supervisor screen and transmits the operation information to the response support server 10.

### <Supervisor Screen>

A supervisor screen provided by the UI processor 103 of the response support server 10 and displayed by the UI 301 of the supervisor terminal 30 will be described in the following.

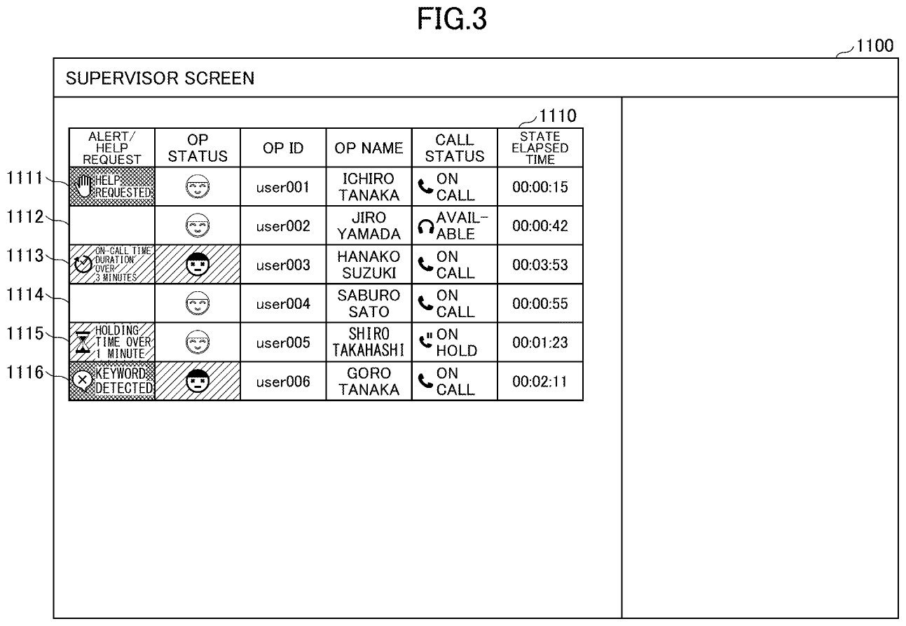

An example of the supervisor screen displayed by the UI 301 of the supervisor terminal 30 is as illustrated in FIG. 3. A supervisor screen 1100 as illustrated in FIG. 3 includes a monitored-operator information field 1110 in which various types of information (hereinafter, also referred to as monitored-operator information) related to the operator to be monitored by the supervisor by using the supervisor terminal 30 is displayed. The monitored-operator information field 1110 of the supervisor screen 1100 as illustrated in FIG. 3 displays monitored-operator information 1111 to monitored-operator information 1116.

Each monitored-operator information displayed in the monitored-operator information field 1110 includes information related to “alert/help request”, “OP status”, “OP ID”, “OP name”, “call status”, and “state elapsed time”.

In an “alert/help request” field, a UI component representing an alert when the alert determiner 102 determines that an event determined to be an alert has occurred is displayed. In addition, in the “alert/help request” field, a UI component representing that a help request has been made is displayed when a help is requested. In the example as illustrated in FIG. 3, the UI component representing that a help has been requested is displayed in the “alert/help request” field of the monitored-operator information 1111, a UI component indicating “on-call time duration over 3 minutes” is displayed in the “alert/help request” field of the monitored-operator information 1113, a UI component indicating “holding time over 1 minute” in the “alert/help request” field of the monitored-operator information 1115, and a UI component indicating “keyword detected” in the “alert/help request” field of the monitored-operator information 1116. Thus, since the supervisor can know whether or not an event determined to be an alert has occurred in the call of each operator and whether or not a help request has been made, the supervisor can determine whether or not to support the operator's telephone response work even when the supervisor or the operator is teleworking.

In an “OP status” field, a UI component representing an operator status is displayed. In the example as illustrated in FIG. 3, the operator status is represented by a face icon representing the presence or absence of psychological stress, for example, a face icon with a smile represents the absence of psychological stress and a face icon with a troubled face represents the presence of psychological stress. Specifically, in the “OP status” fields of the monitored-operator information 1111 to the monitored-operator information 1112 and the monitored-operator information 1114 to the monitored-operator information 1115, a UI component representing an absence of psychological stress is displayed, and in the “OP status” fields of the monitored-operator information 1113 and the monitored-operator information 1116, a UI component representing a presence of psychological stress is indicated. Thus, since the supervisor can know the presence or absence of psychological stress of each operator, the supervisor can determine whether or not to support the operator's telephone response work by referencing the indication of the UI component, even when the supervisor or the operator is teleworking and cannot actually see the operator's face.

However, it is an example that the operator status is indicated by two values, representing the presence and absence of psychological stress, and may be, for example, continuous values or discrete values representing the level of psychological stress. In this case, in the “OP status” field, a UI component (for example, a face icon or the like in which the facial expression varies in stages according to the psychological stress level) corresponding to the level of psychological stress of the operator may be displayed, or a continuous value or a discrete value representing the level of psychological stress may be displayed.

In an “OP ID” filed, identification information (for example, a user ID, an operator ID, etc.) that uniquely identifies the operator is displayed. In an “OP name” field, the name of the operator is displayed. In a “call status” field, a UI component representing a call status (“available”, “on call”, or “on hold”) of the operator is displayed. In a “state elapsed time” field, the elapsed time of the current call status of the operator is displayed. The call status “available” indicates that the operator is ready to start the telephone service, “on call” indicates that the telephone service is currently in progress, and “on hold” indicates that the telephone service is in progress but the call is on hold.

In this way, the presence of an alert, the presence of a help request, and the operator status of each operator are displayed on the supervisor screen. This allows the supervisor to decide whether or not to support the operator's telephone response work, even when the supervisor and the operator cannot see each other or communicate with each other such as by raising a hand because the supervisor himself/herself or the operator is teleworking. Therefore, the supervisor can provide appropriate support at an appropriate timing, and as a result, the quality of telephone response work and customer satisfaction can be enhanced.

It is preferable that a display order of the monitored-operator information displayed in the monitored-operator information field of the supervisor screen is fixed, but the display order may be dynamically changed based on some criteria. For example, according to the psychological stress level represented by the operator status, the monitored-operator information may be displayed from the top in an order higher in the psychological stress level.

### When Checking the Call Contents of the Operator Detected by the Keyword

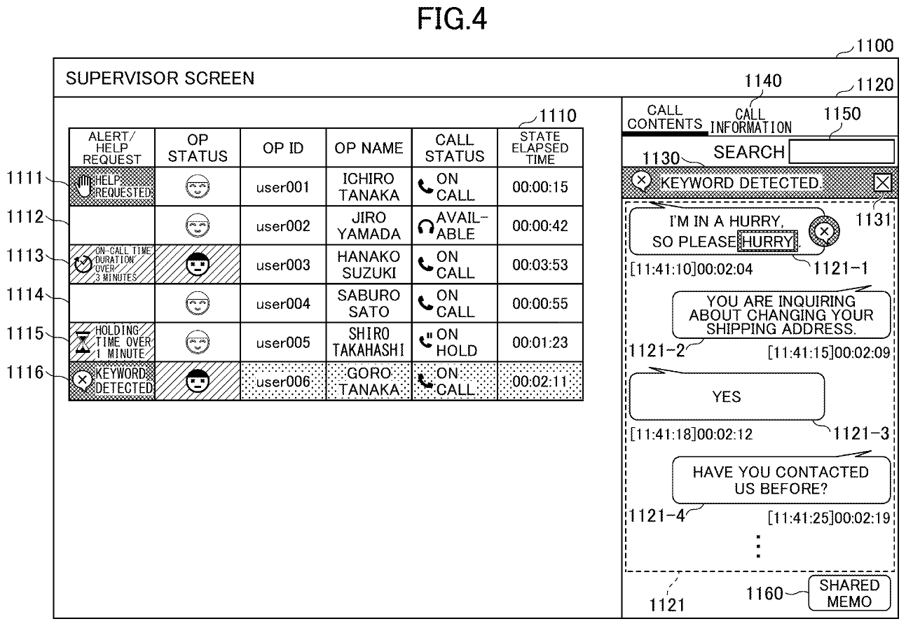

For example, when the monitored-operator information 1116 is selected from the monitored-operator information field 1110 of the supervisor screen 1100 as illustrated in FIG. 3, the supervisor screen 1100 as illustrated in FIG. 4 is displayed by the UI 301 of the supervisor terminal 30. It should be noted that the monitored-operator information 1116 is the information related to an operator making a call (that is, the call in which a keyword is detected) in which a word predetermined to be the target of the “keyword detection” has been detected by the alert determiner 102.

The supervisor screen 1100 as illustrated in FIG. 4 includes a call display field 1120 in which the contents of a call made by the operator corresponding to the monitored-operator information 1116 selected by the supervisor are displayed. The call display field 1120 includes a call contents display field 1121 in which utterance components representing utterance texts of the call is displayed, and an utterance component representing the utterance text in which the keyword is detected is displayed at the top of the call contents display field 1121. In the example as illustrated in FIG. 4, an utterance component 1121-1 to an utterance component 1121-4 are displayed in the call contents display field 1121, and the utterance component 1121-1 represents the utterance text in which a keyword “hurry” is detected.

In the example as illustrated in FIG. 4, the utterance component 1121-1 and the utterance component 1121-3 represent the utterance texts of a customer, and the utterance component 1121-2 and the utterance component 1121-4 represent the utterance texts of the operator.

The call display field 1120 also includes a UI component 1130 representing that the keyword is detected, and a close button 1131 for hiding the UI component 1130. Furthermore, for example, a call information button 1140 for switching the display to information such as a telephone number, a name, call start time, and the like of the customer currently on the call, a search field 1150 for retrieving an utterance text represented by the utterance component of the call contents display field 1121 by a search keyword, and a shared-memo display button 1160 for displaying a shared memo, are also included.

As described above, the supervisor can check the utterance text of the call in which the keyword is detected. Thus, the supervisor can know what kind of keyword is detected, and can determine whether or not to support the operator's telephone response work by considering whether it is likely to lead to a customer grievance (complaint) or the like.

### When Confirming the Contents of the Call of the Operator Whose On-Call Time Duration is Over 3 Minutes

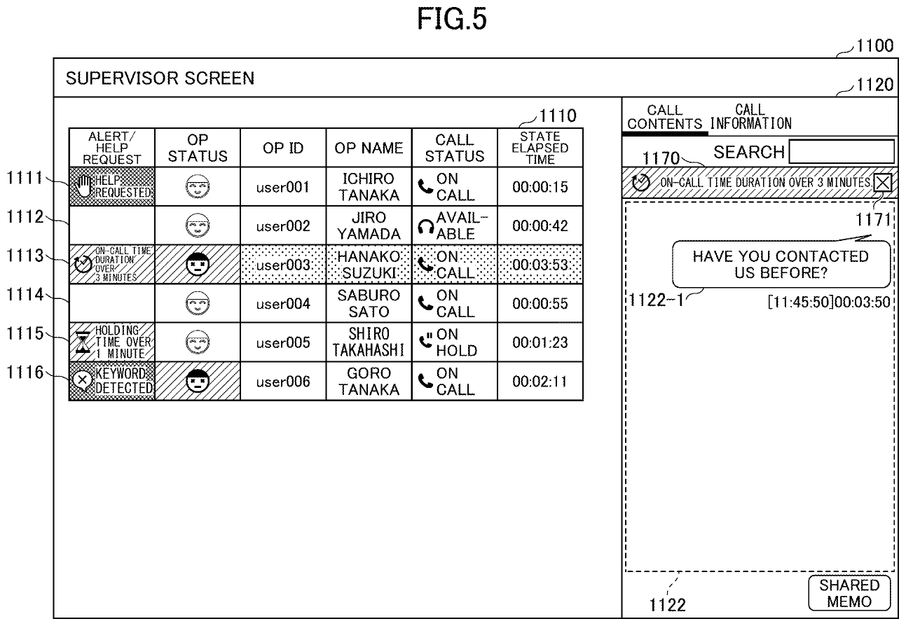

For example, when the monitored-operator information 1113 is selected from the monitored-operator information field 1110 of the supervisor screen 1100 as illustrated in FIG. 3, the UI 301 of the supervisor terminal 30 displays the supervisor screen 1100 as illustrated in FIG. 5. It should be noted that the monitored-operator information 1113 is the information related to an operator whose call (that is, a call taking longer than three minutes) is determined to have occurred an event that corresponds to “on-call time duration over 3 minutes” by the alert determiner 102.

The supervisor screen 1100 as illustrated in FIG. 5 includes the call display field 1120 which displays the contents of the call or the like performed by the operator corresponding to the monitored-operator information 1113 selected by the supervisor. The call display field 1120 includes a call contents display field 1122 in which an utterance component representing the utterance text of the call is displayed, and an utterance component representing the latest utterance text is displayed at the top of the call contents display field 1122. In the example as illustrated in FIG. 5, an utterance component 1122-1 is displayed in the call contents display field 1122, and the utterance component 1122-1 is the utterance component representing the latest utterance text. However, in the call contents display field 1122, for example, the utterance component representing the utterance text when the length of on-call time duration exceeds the threshold value “3 minutes” may be displayed at the top.

In the example as illustrated in FIG. 5, the utterance component 1122-1 represents the utterance text of the operator.

In addition, the call display field 1120 includes a UI component 1170 representing that the length of the on-call time duration exceeds 3 minutes, and a close button 1171 for hiding the UI component 1170.

As described above, the supervisor can confirm the utterance text of the call whose on-call time duration length exceeds the predetermined threshold value. Thus, the supervisor can recognize the utterance contents of the call whose on-call time duration is long, and can determine whether or not to support the operator's telephone response work by considering whether it is likely to lead to a customer grievance (complaint) or the like.

In addition, since the utterance component representing the latest utterance text is displayed at the top of the call contents display field 1122, the latest utterance text is displayed at a position close to the UI component 1170, and thus, it is possible to readily grasp a response status from the latest utterance text, etc., together with the content of the “alert/help request” that the length of the on-call time duration exceeds 3 minutes.

However, the display position of the UI component 1170 as illustrated in FIG. 5 is an example, and for example, the UI component 1170 may be displayed at either the upper left corner or the upper right corner of the call contents display field 1122, and the UI component 1170 may be displayed at the upper left corner or the upper right corner of the call contents display field 1122 in relation to the display position of the utterance component representing the utterance text corresponding to the speaker. Also, displaying the utterance component representing the latest utterance text at the top of the call contents display field 1122 is an example, and the display position can be changed as needed. For example, the utterance component representing the latest utterance text may be displayed at the bottom of the call contents display field 1122, and in this case, the UI component 1170 may also be displayed at either the lower left corner or the lower right corner of the call contents display field 1122, and furthermore, the UI component 1170 may be displayed at the upper left corner or the upper right corner of the call contents display field 1122 in relation to the display position of the utterance component representing the utterance text corresponding to the speaker.

### When Confirming the Contents of a Call Of an Operator Whose Holding Time Exceeds 1 Minute

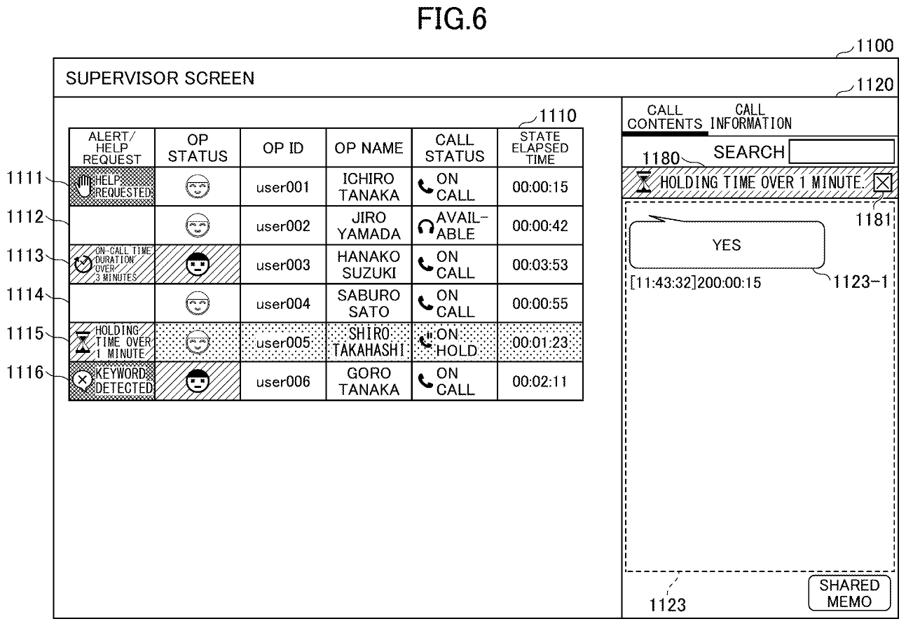

For example, when the monitored-operator information 1115 is selected from the monitored-operator information field 1110 of the supervisor screen 1100 as illustrated in FIG. 3, the UI 301 of the supervisor terminal 30 displays the supervisor screen 1100 as illustrated in FIG. 6. It should be noted that the monitored-operator information 1115 is the information related to the operator handling the call (that is, the call whose holding time exceeds one minute) for which the alert determiner 102 has determined that an event that corresponds to the “holding time over 1 minute” has occurred.

The supervisor screen 1100 as illustrated in FIG. 6 includes the call display field 1120 for displaying the contents of a call made by an operator corresponding to the monitored-operator information 1115 selected by the supervisor. The call display field 1120 includes a call contents display field 1123 for displaying utterance components representing utterance texts of a call, and the utterance component representing the latest utterance text is displayed at the top of the call contents display field 1123. In the example as illustrated in FIG. 6, the call contents display field 1123 displays an utterance component 1123-1, and the utterance component 1123-1 is the utterance component representing the latest utterance text. However, in the call contents display field 1123, for example, the utterance component representing the utterance text when the threshold value “1 minute” for the holding time is exceeded may be displayed at the top.

In the example as illustrated in FIG. 6, the utterance component 1123-1 represents the utterance text of the customer.

The call display field 1120 also includes a UI component 1180 representing that the holding time has exceeded 1 minute, and a close button 1181 for hiding the UI component 1180.

In this way, the supervisor can confirm the utterance text of the call in which the holding time exceeds the predetermined threshold value. Thus, the supervisor can recognize the utterance contents of the call in which the holding time is long, and can determine whether or not to support the operator's telephone response work by considering whether it is likely to lead to a customer grievance (complaint) or the like.

Moreover, since the utterance component representing the latest utterance text is displayed at the top of the call contents display field 1123, the latest utterance text is displayed at a position close to the UI component 1180, and it is possible to readily grasp the response status from the latest utterance text or the like along with the content of the “alert/help request” that the holding time exceeds 1 minute.

However, the display position of the UI component 1180 as illustrated in FIG. 6 is an example, and for example, the UI component 1180 may be displayed at either the upper left corner or the upper right corner of the call contents display field 1123, and the UI component 1180 may be displayed at the upper left corner or the upper right corner of the call contents display field 1123 in relation to the display position of the utterance component representing the utterance text corresponding to the speaker. Also, displaying the utterance component representing the latest utterance text at the top of the call contents display field 1123 is an example, and the display position can be changed as needed. For example, the utterance component representing the latest utterance text may be displayed at the bottom of the call contents display field 1123, and in this case, the UI component 1180 may also be displayed at either the lower left corner or the lower right corner of the call contents display field 1123, and furthermore, the UI component 1180 may be displayed at the upper left corner or the upper right corner of the call contents display field 1123 in relation to the display position of the utterance component representing the utterance text corresponding to the speaker.

### When Confirming the Call Contents of an Operator Who has Made a Help Request

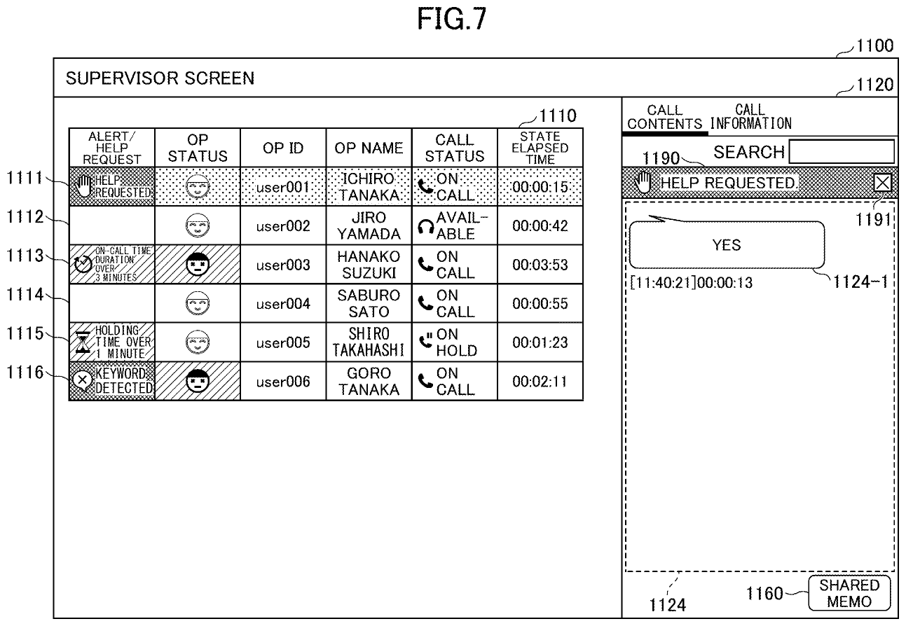

For example, when the monitored-operator information 1111 is selected from the monitored-operator information field 1110 of the supervisor screen 1100 as illustrated in FIG. 3, the supervisor screen 1100 as illustrated in FIG. 7 is displayed by the UI 301 of the supervisor terminal 30. The monitored-operator information 1111 is the information related to the operator of the call for which the help request has been made.

The supervisor screen 1100 as illustrated in FIG. 7 includes the call display field 1120 for displaying the contents of the call in which the operator corresponding to the monitored-operator information 1111 selected by the supervisor is in charge. The call display field 1120 includes a call contents display field 1124 for displaying utterance components representing utterance texts of the call, and the utterance component representing the latest utterance text is displayed at the top of the call contents display field 1124. In the example as illustrated in FIG. 7, an utterance component 1124-1 is displayed in the call contents display field 1124, and the utterance component 1124-1 is the utterance component representing the latest utterance text.

In the example as illustrated in FIG. 7, the utterance component 1124-1 represents the utterance text of the customer.

The call display field 1120 also includes a UI component 1190 indicating that a help request has been made and a close button 1191 for hiding the UI component 1190.

As described above, the supervisor can confirm the utterance texts of the call for which the help request has been made. Thus, the supervisor can determine whether or not to support the telephone response work of the call for which the help request has been made.

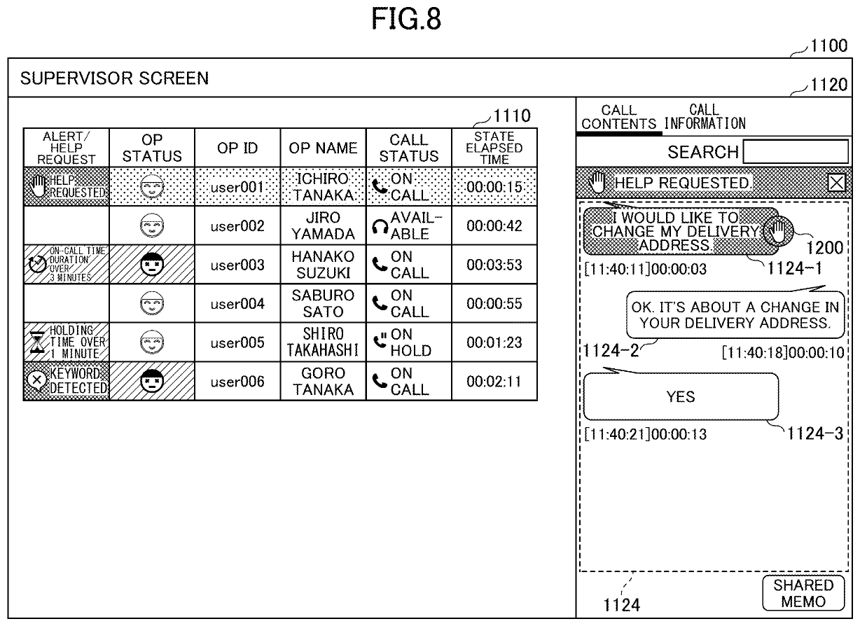

Here, the help request by the operator may be made by specifying the utterance text, and in this case, the utterance component representing the utterance text specified in the help request is displayed in the call contents display field 1124 in a manner different from other utterance components. For example, when the help request specifying the utterance text represented by the utterance component 1124-1 is made, the utterance component 1124-1 is displayed in a manner different from an utterance component 1124-2 and an utterance component 1124-3, as illustrated in FIG. 8. In addition, the utterance component 1124-1 is provided with a help start icon 1200 for displaying, for example, a shared memo or the like to start support. Thus, the supervisor can quickly provide support to the help request specified with the utterance text.

For example, when the operator status of the operator who made the help request changes, a display mode (for example, color, etc.) of the UI component 1190 of the supervisor screen 1100 as illustrated in FIG. 7 may be changed (in particular, changing to the display mode that corresponds to the operator status after the change). Similarly, when the operator status of the operator who made the help request with specified utterance text changes, the display mode (for example, color, etc.) of the utterance component 1124-1 of the supervisor screen 1100 as illustrated in FIG. 8 may be changed (in particular, changing to the display mode that corresponds to the operator status after the change).

### Supervisor Screen Including Shared Memos

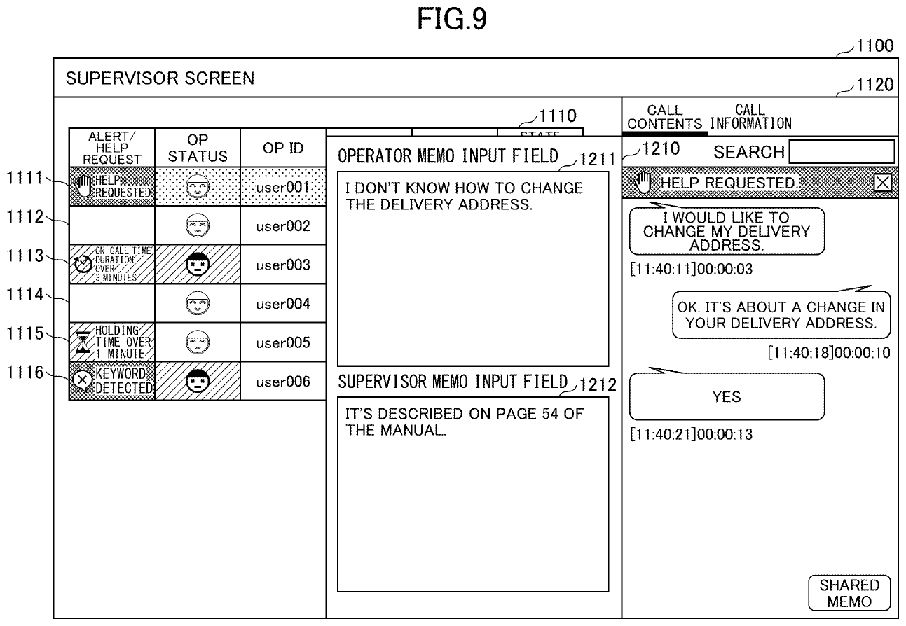

For example, when the shared-memo display button or the help start icon is selected on the supervisor screen, the supervisor screen 1100 as illustrated in FIG. 9 is displayed by the UI 301 of the supervisor terminal 30. The supervisor screen 1100 as illustrated in FIG. 9 represents the supervisor screen when the shared-memo display button 1160 is selected in the example as illustrated in FIG. 7.

The supervisor screen 1100 as illustrated in FIG. 9 includes a shared-memo field 1210 composed of an operator memo input field 1211 in which the memo entered by the operator handling the call is displayed and a supervisor memo input field 1212 in which the supervisor can input a memo. The memo entered in the supervisor memo input field 1212 is displayed on the operator screen of the operator terminal 20 used by the operator handling the call. Therefore, by inputting a memo indicating the support contents into the supervisor memo input field 1212 by the supervisor, the supervisor can support the telephone response work of the operator.

For example, in the example as illustrated in FIG. 9, “I don't know how to change the delivery address.” is input in the operator memo input field 1211, and “It's described on page 54 of the manual.” is input in the supervisor memo input field 1212 by the supervisor.

### <Operator Screen>

An operator screen provided by the UI processor 103 of the response support server 10 and displayed by the UI 202 of the operator terminal 20 will be described in the following.

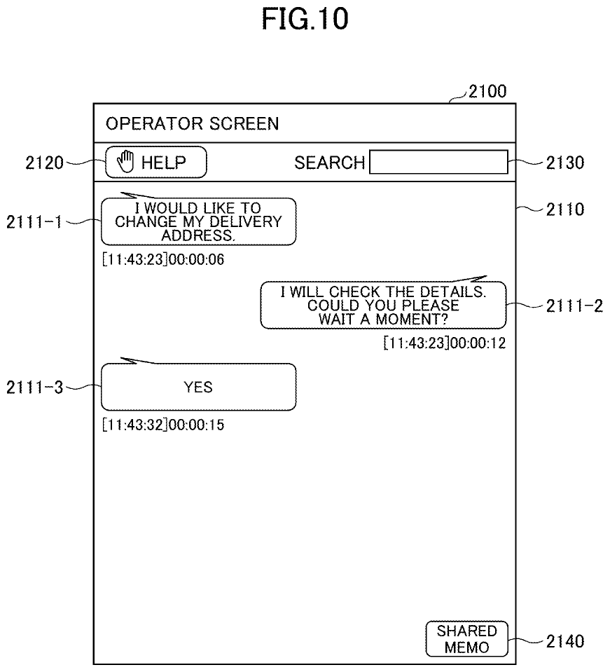

An example of the operator screen displayed by the UI 202 of a certain operator terminal 20 is illustrated in FIG. 10. An operator screen 2100 as illustrated in FIG. 10 displays a call contents display field 2110 in which the contents of a call between the operator and the customer are displayed. The call contents display field 2110 displays the utterance components representing the utterance texts of the call in real time. In the example as illustrated in FIG. 10, an utterance component 2111-1 to an utterance component 2111-3 are displayed in the call contents display field 2110.

In the example as illustrated in FIG. 10, the utterance component 2111-1 and the utterance component 2111-3 represent the utterance texts of the customer, and the utterance component 2111-2 represents the utterance text of the operator.

The operator screen 2100 as illustrated in FIG. 10 also includes a help request button 2120 for requesting help to the supervisor who monitors the operator, a search field 2130 for retrieving the utterance text represented by the utterance component in the call contents display field 2110 by a search keyword, and a shared-memo display button 2140 for displaying shared memos.

Thus, the operator can confirm the contents of the call with the customer in real time on the operator screen, request help to the supervisor who monitors the operator, and communicate with the supervisor by shared memos.

### When a Help Request is Made

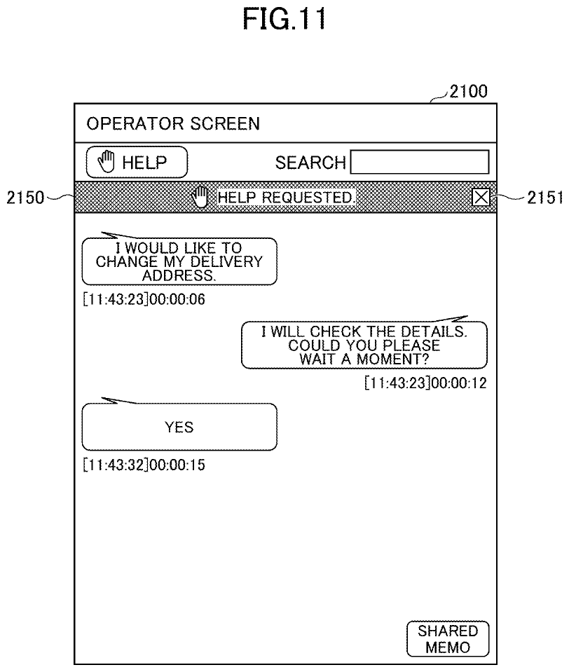

For example, when the help request button 2120 is selected on the operator screen 2100 as illustrated in FIG. 10, the operator screen 2100 as illustrated in FIG. 11 is displayed by the UI 301 of the operator terminal 20.

The operator screen 2100 as illustrated in FIG. 11 includes a UI component 2150 indicating that the help request has been made and a close button 2151 for hiding the UI component 2150. By the UI component 2150, the operator can confirm that a help request has been made to the supervisor monitoring the operator.

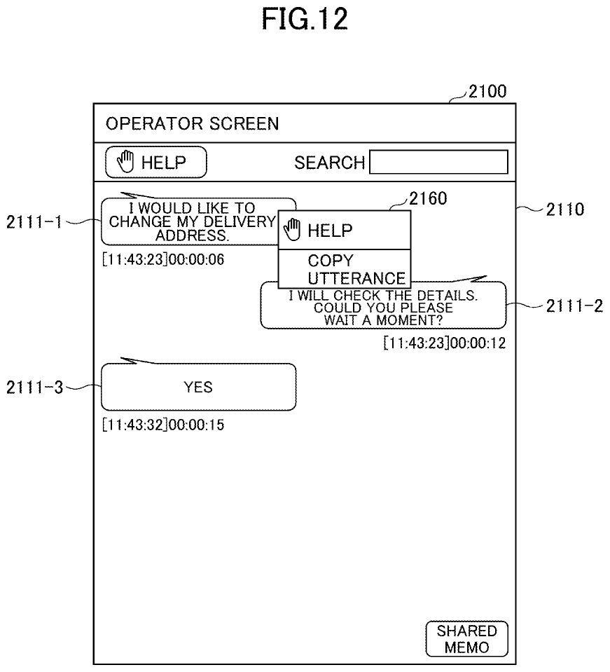

Here, the operator can also make a help request by specifying an utterance text. When making a help request by specifying an utterance text, the operator only need to make a help request after selecting (for example, mousing over or the like) an utterance component representing the utterance text. For example, as illustrated in FIG. 12, the operator can select the “help” button from the menu 2160 displayed by selecting the utterance component 2111-1. In this way, the operator can make a help request specified with the utterance text represented by the utterance component 2111-1. A menu 2160 may include a “copy utterance” button for copying the utterance text represented by the utterance component 2111-1 to a clipboard or the like.

It should be noted that when the operator makes a help request, the supervisor monitoring the operator may be supporting another operator and may not be able to immediately respond to the help request. Therefore, when the supervisor is supporting another operator, for example, a UI component representing “Help requested (currently assisting another operator).” or “Help requested (currently dealing with another case).” may be displayed instead of the UI component 2150.

### When the Supervisor Confirmed the Help Request

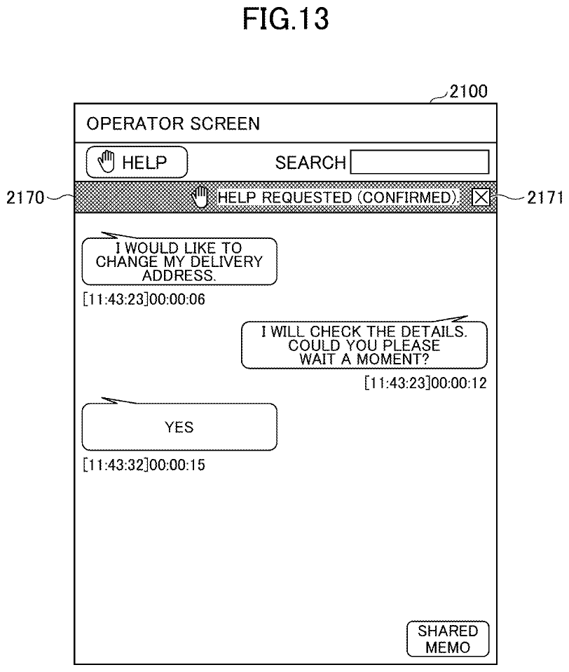

When the supervisor confirmed the help request, it may be notified on the operator screen. For example, when the supervisor confirmed the Help request, as illustrated in FIG. 13, a UI component 2170 indicating that the help request has been confirmed by the supervisor may be displayed. In this UI component 2170, for example, “Help requested (confirmed).” is displayed, and the operator can know that his/her help request has been confirmed by the supervisor. Thus, for example, even when the operator or the supervisor is teleworking, the operator can know that his/her help request has been confirmed by the supervisor and that he/she will soon receive support. Note that a close button 2171 for hiding the UI component 2170 may exist.

Here, for example, in the example as illustrated in FIG. 7, when the UI component 1190 is selected by the supervisor, it can be assumed that the help request has been confirmed by the supervisor. When the help request is confirmed by the supervisor, information notifying that the operator is in charge of the help request is displayed (for example, the UI component 1190 is changed to a UI component representing information indicating that the operator is in charge of the call to which the help is requested and displayed) on the supervisor screen 1100 to be confirmed by the supervisor. In contrast to this, information indicating that a supervisor A is in charge of the help request is displayed (for example, the UI component 1190 is changed to a UI component representing information that the supervisor A is in charge of the help request and displayed) on the supervisor screens 1100 to be confirmed by supervisors other than the supervisor in charge of the help request (hereinafter referred to as supervisor A).

In addition to the case where the UI component 1190 is selected by the supervisor, for example, when the UI component 1190 is hidden by selecting the close button 1191, it can be considered that the help request has been confirmed by the supervisor. In the example as illustrated in FIG. 8, it can be considered that the help request is confirmed by the supervisor when the help start icon 1200 is selected by the supervisor. In addition to these, for example, in the example as illustrated in FIG. 7, it can be considered that the help request is confirmed when the call display field 1120 is hidden by the supervisor, when the monitored-operator information 1111 is pressed or selected by the supervisor, or when other predetermined operations are performed by the supervisor. In addition, when the help request is confirmed by the supervisor, information indicating that the supervisor has confirmed the help request may be notified to the operator who has made the help request, may record that the supervisor is responding to the operator's help, or may notify the operator, other operators, and other supervisors of the status of the supervisor who has confirmed the help request.

In the example as illustrated in FIG. 13, that the supervisor has confirmed the help request is indicated by adding a word “confirmed” in the UI component 2170, however, this is only an example, and other methods may be used to indicate that the help request is confirmed by the supervisor. For example, the color of the UI component indicating that the help request has been made may be changed to a predetermined color.

### Operator Screen Including Shared Memo

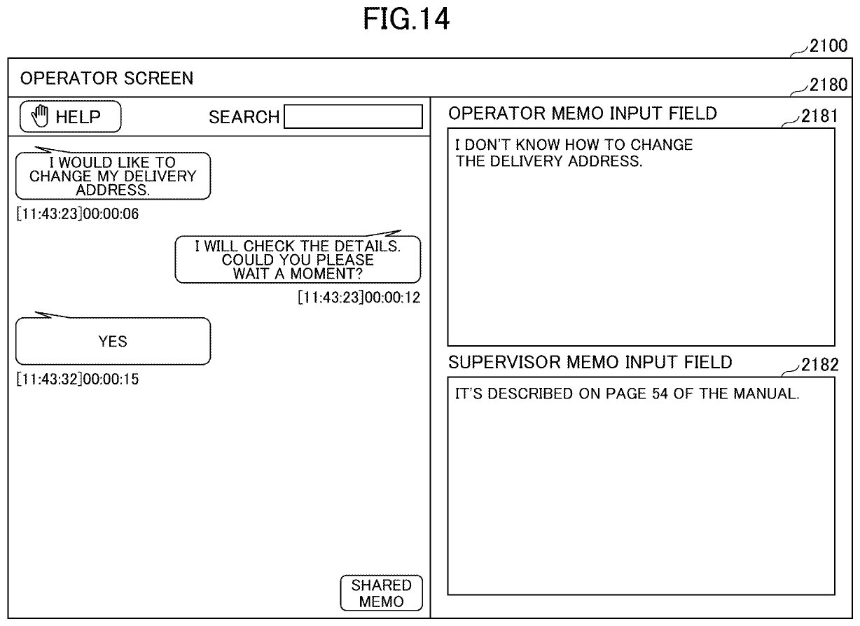

For example, when the shared-memo display button or the help request button is selected on the operator screen, the operator screen 2100 as illustrated in FIG. 14 may be displayed by the UI 202 of the operator terminal 20. The operator screen 2100 as illustrated in FIG. 14 represents the operator screen once the shared-memo display button 2140 is selected in the example as illustrated in FIG. 10.

The operator screen 2100 as illustrated in FIG. 14 includes a shared-memo field 2180 composed of an operator memo input field 2181 in which the operator can input a memo and a supervisor memo input field 2182 in which a memo input by the supervisor is displayed. The memo input in the operator memo input field 2181 is displayed on the supervisor screen of the supervisor terminal 30 used by the supervisor who supports the operator's telephone response work. Therefore, by inputting a memo indicating contents to which the operator needs supervisor's support in the operator memo input field 2181, the operator can convey the contents to which the supervisor's support is needed to the supervisor who monitors the operator.

For example, in the example as illustrated in FIG. 14, “I don't know how to change the delivery address.” is input in the operator memo input field 2181, while “It's described on page 54 of the manual.” is input in the supervisor memo input field 2182 by the supervisor.

### <Modified Example of Supervisor Screen>

As a modified example of the supervisor screen described in the above embodiments, for example, a supervisor screen composed of windows independent of each operator may be displayed.

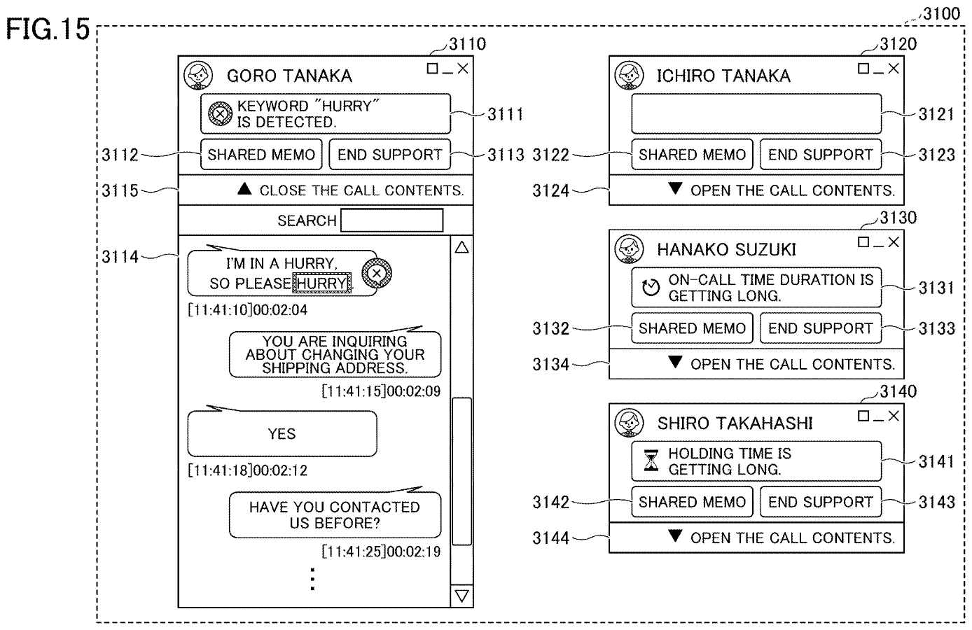

For example, a supervisor screen 3100 as illustrated in FIG. 15 includes a window 3110 of the OP name “Goro Tanaka”, a window 3120 of the OP name “Ichiro Tanaka”, a window 3130 of the OP name “Hanako Suzuki”, and a window 3140 of the OP name “Shiro Takahashi”.

Furthermore, the window 3110 includes an alert/help field 3111 in which words or the like indicating an alert or a help request are displayed, a shared-memo display button 3112 for displaying a shared memo, a support end button 3113 for ending support for the operator, a call contents display field 3114 for displaying the call content, and a close button 3115 for hiding the call contents display field 3114.

Furthermore, the window 3120 includes an alert/help field 3121 in which words or the like indicating an alert or a help request are displayed, a shared-memo display button 3122 for displaying a shared memo, a support end button 3123 for ending support for the operator, and an open button 3124 for displaying the call contents display field.

Similarly, the window 3130 includes an alert/help field 3131 in which words or the like indicating an alert or a help request are displayed, a shared-memo display button 3132 for displaying a shared memo, a support end button 3133 for ending support for the operator, and an open button 3134 for displaying the call contents display field.

Similarly, the window 3140 includes an alert/help field 3141 in which words or the like indicating an alert or a help request are displayed, a shared-memo display button 3142 for displaying a shared memo, a support end button 3143 for ending support for the operator, and an open button 3144 for displaying a call contents display field.

In this manner, the supervisor may monitor the calls of each operator on the supervisor screen which is composed of windows independent of each operator. Thus, the supervisor can efficiently monitor a plurality of operators simultaneously and concurrently.

Among the plurality of windows, the call contents display field may be displayed only in the window related to the call of the operator currently supported by the supervisor. For example, in the example as illustrated in FIG. 16, the window related to the call of the operator currently supported by the supervisor is window 3110, and the call contents display field 3114 is displayed only in this window 3110.

Furthermore, in the windows 3110 to 3140, the expression of the face icon may be changed, decorations such as an exclamation mark may be added or deleted from the face icon, and a display mode (font, color, flashing, etc.) of the name or characters in the window may be changed according to the operator status (including alerts, help requests, etc.) of the operator corresponding to the window.

### <Another Modified Example>

In the above embodiment, when a help request is confirmed by the supervisor, the word “confirmed” is indicated in the UI component indicating that the help request has been made. However, in addition to this, for example, when the help (support) by the supervisor ends, a word “end” may be indicated in the UI component, or the color of the UI component may be changed to a predetermined color.

### SUMMARY

As described above, the response support server 10 according to the present embodiment provides the supervisor with the supervisor screen including an alert detected during a call between an operator and a customer and an operator status indicating a psychological stress level of the operator. Thus, even when the supervisor is teleworking or the operator is teleworking, the supervisor can detect an issue during the call between the operator and the customer at an early stage and can readily determine whether or not a support is necessary.

In addition, the response support server 10 according to the present embodiment provides the operator with an operator screen including a UI component capable of making a help request to the supervisor and a status of the help request (whether it has been confirmed by the supervisor, whether or not the supervisor is dealing with another case, etc.). Thus, even when the operator is teleworking or the supervisor is teleworking, the operator can readily make a help request to the supervisor and can readily know the confirmation status of the supervisor for the help request.

The present invention is not limited to the embodiments specifically disclosed above, and various modifications, changes, combinations with known techniques, etc., are possible without departing from the claims.

REFERENCE SIGNS LIST

| | |
|---|---|
| 1 | Contact center system |
| 10 | Response support server |
| 20 | Operator terminal |
| 30 | Supervisor terminal |
| 40 | IP-PBX |
| 50 | Customer terminal |
| 60 | Network |
| 101 | Operator-state determiner |
| 102 | Alert determiner |
| 103 | UI processor |
| 201 | State-determination information transmitter |
| 202 | UI |
| 301 | UI |

1. A response support device comprising a processor configured to execute operations comprising:
identifying, based on an occurrence of a specific event of a first user, warning information, wherein the first user uses a first terminal to provide customer service through a communication operation; and
presenting, based on the warning information, a first screen to a second user terminal used by a second user, wherein the first screen comprises state information and the warning information,
the state information represents a state of the first user, and
the second user provides support to the customer service as performed by the first user.

2. The response support device according to claim 1, the processor further configured to execute operations comprising:
determining the state of the first user based on information obtained by a first user terminal used by the first user.

3. The response support device according to claim 1, the processor further configured to execute operations comprising:
determining the occurrence of the specific event during the communication operation.

4. The response support device according to claim 1, wherein
the first screen comprises support request information indicating that the first user has requested support for the customer service, and
the presenting further comprises presenting a second screen to the first user terminal, the second screen comprises a first operation part that cause transmitting a request by the first user to the second user for the support for the customer service.

5. The response support device according to claim 4, wherein
the second screen comprising: the second screen comprises:
a first display part indicating utterance content of communication between the first user and a customer during a customer service call, and
a second operation part comprising an indication of a request to the second user for the support for the customer service by the first user interactively specifying the first display part in a graphical user interface.

6. The response support device according to claim 4, wherein
the presenting further comprises:
presenting the second screen to the first user terminal upon requesting the support for the customer service to the second user, the second screen being provided with a second display part indicating that a request has been made, and
presenting the second screen to the first user terminal upon confirmation of the request by the second user, the second screen being provided with a third display part indicating that the request has been confirmed.

7. A computer implemented method for supporting response operations,
identifying, based on an occurrence of a specific event of a first user, warning information, wherein the first user uses a first terminal to provide customer service through a communication operation; and
presenting, based on the warning information, a first screen to a second user terminal used by a second user,
wherein the first screen comprises state information and the warning information,
the state information represents a state of the first user, and
the second user provides support to the customer service as performed by the first user.

8. A non-transitory computer-readable recording medium storing a computer-executable program instructions that when executed by a processor cause a computer to execute operations comprising:
identifying, based on an occurrence of a specific event of a first user, warning information, wherein the first user uses a first terminal to provide customer service through a communication operation; and
presenting, based on the warning information, a first screen to a second user terminal used by a second user,
wherein the first screen comprises state information and the warning, information,
the state information represents a state of the first user, and
the second user provides support to the customer service as performed by the first user.

9. The response support device according to claim 1, wherein the specific event comprises an on-call time duration of the customer service exceeding a predetermined threshold value.

10. The response support device according to claim 1, wherein the specific event comprises a holding time duration of the customer service exceeding a predetermined threshold value.
